(19) United States
(12) Patent Application Publication
(10) Pub. No.: US 2012/0054805 A1
(43) Pub. Date: Mar. 1, 2012

(54) HOME NETWORK FREQUENCY CONDITIONING DEVICE

(75) Inventors: Steven K. Shafer, Chittenango, NY (US); Erdogan Alkan, Fayetteville, NY (US)

(73) Assignee: JOHN MEZZALINGUA ASSOCIATES, INC., East Syracuse, NY (US)

(21) Appl. No.: 13/178,149

(22) Filed: Jul. 7, 2011

Related U.S. Application Data
(60) Provisional application No. 61/378,126, filed on Aug. 30, 2010.

(51) Int. Cl. H04N 21/40

(52) U.S. Cl. 725/78

(57) ABSTRACT

This invention disclosure relates to a conditioning device for improving the frequency response of signals conducted within an in-home cable infrastructure that includes both CATV bandwidth and in-home entertainment bandwidth. Disclosed is a CATV network device which includes a CATV signal transmission path and an in-home entertainment signal transmission path. Also disclosed is a signal conditioning circuit that is placed along the in-home entertainment signal transmission path. The signal conditioning circuit includes at least one LC resonant shunt circuit and at least one LC resonant tank circuit. In a particular embodiment two signal conditioning circuits are used. The CATV network device attenuates and equalizes the in-home entertainment signals transmitted along the in-home entertainment signal path so that the in-home entertainment signals don't interfere with the CATV signals.

### CROSS REFERENCE TO RELATED APPLICATION

This application claims priority to U.S. Provisional Patent Application to Shafer, et al, entitled “Home Network Frequency Conditioning Device,” Ser. No. 61/378,126, filed Aug. 30, 2010, the disclosure of which is hereby incorporated entirely herein by reference.

### Field of the Invention

This disclosure relates generally to community access or cable television (CATV) networks and to in-home entertainment (IHE) networks. More particularly, the present disclosure relates to a conditioning device for improving the frequency response of signals conducted within an in-home cable infrastructure that includes both CATV bandwidth and in-home entertainment bandwidth.

### BACKGROUND OF THE INVENTION

Community access television, or cable television, (CATV) networks use an infrastructure of interconnected coaxial cables, splitters, amplifiers, filters, trunk lines, cable taps, drop lines and other signal-conducting devices to supply and distribute high frequency “downstream” signals from a main signal distribution facility, known as a head-end, toward subscriber premises such as homes and businesses. The downstream signals operate the subscriber equipment, such as television sets, telephones, and computers. The typical CATV network is a two-way communication system. CATV networks also transmit “upstream” signals from the subscriber equipment back to the head-end of the CATV network. For example, upstream bandwidth may include data related to video-on-demand services, such as video requests and billing authorization. Two-way communication is also utilized when using a personal computer connected through the CATV infrastructure to the public Internet, for example when sharing photo albums or entering user account information. In yet another example, voice over Internet protocol (VOIP) telephones and security monitoring equipment use the CATV infrastructure and the public Internet as the communication medium for transmitting two-way telephone conversations and monitoring functions.

To permit simultaneous communication of upstream and downstream CATV signals and the interoperability of the subscriber equipment and the equipment associated with the CATV network infrastructure outside of subscriber premises, the downstream and upstream CATV signals are confined to two different frequency bands. In most CATV networks the downstream frequency band, or downstream bandwidth, is within the range of 54-1002 megahertz (MHz) and the upstream frequency band, or upstream bandwidth, is within the range of 5-42 MHz.

The downstream signals are delivered from the CATV network infrastructure to the subscriber premises at a CATV entry adapter, which is also commonly referred to as an entry device, terminal adapter or a drop amplifier. The entry adapter is a multi-port device which connects at a premises entry port to a CATV drop cable from the CATV network infrastructure. The entry adapter connects at a multiplicity of other distribution ports to coaxial cables which extend throughout the subscriber premises to a cable outlet. Each cable outlet is available to be connected to subscriber equipment. Typically, most homes have coaxial cables extending to cable outlets in almost every room, because different types of subscriber equipment may be used in different rooms. For example, television sets, computers and telephone sets are commonly used in many different rooms of a home or office. The multiple distribution ports of the entry adapter deliver the downstream signals to each cable outlet and conduct the upstream signals from the subscriber equipment through the entry adapter to the drop cable and the CATV infrastructure.

In addition to television sets, computers and telephones, a relatively large number of other entertainment and multimedia devices are available for use in homes. For example, a digital video recorder (DVR) is used to record broadcast programming, still photography and moving pictures in a memory medium so that the content can be replayed on a display or television set at a later time selected by the user. As another example, computer games are also played at displays or on television sets. Such computer games may be those obtained over the Internet from the CATV network or from media played on play-back devices connected to displays or television sets. In another example, receivers of satellite-broadcast signals may be distributed for viewing or listening throughout the home. These types of devices, including the more-conventional television sets, telephone sets and devices connected to the Internet by the CATV network, are generically referred to as multimedia devices.

An in-home entertainment network may be coupled to the CATV network via the same coaxial cable delivering the downstream and upstream bandwidth of the CATV system. The in-home entertainment network can be a network providing multiple streams of high definition video and gaming entertainment. Examples of in-home entertainment network technologies include Ethernet, HomePlug, Home Phoneline Networking Alliance (HPNA), Multimedia over Coax Alliance (MoCA) and 802.11n protocols. The in-home entertainment (IHE) network is coupled to the CATV network within a subscriber premises to allow the CATV network to distribute IHE signals from one multimedia device to another within the subscriber premises.

Since the operation of the subscriber premises IHE network must occur simultaneously with the operation of the CATV services, the IHE signals often utilize a frequency range different from the frequency ranges of the CATV upstream and downstream signals. A typical IHE frequency band is 1125-1675 MHz, which is referred to in this document as the multimedia-over-coax frequency range, or bandwidth. A specific IHE network technology can includes other frequency ranges, but the 1125 to 1675 MHz frequency range is of major relevance because of its principal use in establishing connections between the multimedia devices within a subscriber network.

Although using the in-home cable infrastructure as the communication medium substantially simplifies the implementation of the IHE network, there are certain disadvantages to doing so. One noted problem arises when multimedia-over-coax signals pass backwards through a conventional splitter en route to another multimedia-over-coax-enabled device within the network. The CATV network and the in-home cable infrastructure were originally intended for the distribution of CATV signals. The typical in-home cable infrastructure uses signal splitters to divide CATV downstream signals into multiple CATV downstream paths and to combine multiple CATV upstream signals into a single CATV upstream path. The CATV entry adapter was not originally intended to communicate multimedia-over-coax signals between its ports, as is necessary to achieve multimedia-over-coax signal communication in the IHE network. To implement the IHE network, the multimedia-over-coax signals must traverse between separate signal component legs of a signal splitter/combiner which are connected to the multiple ports.

The typical signal splitter has a high degree of signal rejection or isolation between its separate signal component legs. When the multimedia-over-coax signals traverse between the separate signal component legs of the splitter, the degree of signal rejection or isolation greatly attenuates the strength of the multimedia-over-coax signals. This it is desirable to have a system which transmits both CATV and IHE signals without attenuating or rejecting the IHE signals to a large degree.

Some IHE network communication protocols recognizes the possibility of variable strength multimedia-over-coax signals and provide the capability to boost the strength of multimedia-over-coax signals to compensate for the variable strength of the multimedia-over-coax signals that would otherwise be communicated between multimedia-over-coax-enabled devices. However, boosting the strength of the multimedia-over-coax signal can result in the strength or power of the multimedia-over-coax signals being substantially greater than the strength or power of the CATV signals communicated within the subscriber premises. Consequently, the multimedia-over-coax signals have the capability of adversely affecting the proper functionality of standard CATV subscriber equipment, such as a digital video recorder or an embedded multimedia terminal adapter (eMTA). This it is desirable to have a device for use in a CATV network which conditions the IHE signals transmitted through the network such that the IHE signals will not be rejected, without adversely affecting the CATV communication occurring simultaneously on the CATV network.

### SUMMARY OF THE INVENTION

This disclosure relates generally to community access or cable television (CATV) networks and to in-home entertainment (IHE) networks. More particularly, the present disclosure relates to a conditioning device for improving the frequency response of signals conducted within an in-home cable infrastructure that includes both CATV bandwidth and in-home entertainment bandwidth. Disclosed is a CATV network device which includes a CATV signal transmission path, where the CATV signal transmission path conducts CATV downstream signals in a first frequency range and CATV upstream signals in a second frequency range that is different from the first frequency range. The CATV signal transmission path also rejects in-home entertainment (IHE) signals in a third frequency range that is different from the first frequency range and the second frequency range. The CATV network device also includes an IHE signal transmission path that conducts CATV downstream signals in the first frequency range, CATV upstream signals in the second frequency range, and IHE signals in the third frequency range. In some embodiments the IHE signal transmission path includes a signal conditioning circuit that has at least one LC resonant shunt circuit and at least one LC resonant tank circuit. In some embodiments the IHE signal transmission path includes two signal conditioning circuits that each have at least one LC resonant shunt circuit and at least one LC resonant tank circuit. In some embodiments the IHE signals in the third frequency range are attenuated an amount in the range of −1 dB to −30 dB in response to passing through the two signal conditioning circuits. In some embodiments the IHE signals in the third frequency range are attenuated an amount in the range of −15 dB to −20 dB in response to passing through the two signal conditioning circuits.

Disclosed is a signal conditioning circuit for CATV equipment which includes an IHE signal transmission path, where the IHE signal transmission path conducts IHE signals between a first node and a second node. The signal conditioning circuit also includes a first LC resonant shunt circuit. The first LC resonant shunt circuit has a first LC resonant shunt circuit first end electrically coupled to the IHE signal transmission path and a first LC resonant shunt circuit second end electrically coupled to a current return path. The first LC resonant shunt circuit also has a first capacitor, a first inductor in series with the first capacitor, and a first resistor in parallel with the first inductor. The signal conditioning circuit also includes a first LC resonant tank circuit coupled in series along the IHE signal transmission path, where the first LC resonant tank circuit includes a second inductor in parallel with a second capacitor. In some embodiments the first resistor is in parallel with both the first inductor and the first capacitor. In some embodiments the first LC resonant tank circuit includes a second resistor in parallel with the second capacitor. In some embodiments the first LC resonant tank circuit includes a second resistor in series with the second capacitor.

In some embodiments the signal conditioning circuit also includes a second LC resonant shunt circuit. The second LC resonant shunt circuit has a second LC resonant shunt circuit first end electrically coupled to the IHE signal transmission path and a second LC resonant shunt circuit second end electrically coupled to a current return path. The second LC resonant shunt circuit also has a third capacitor, a third inductor in series with the third capacitor, and a third resistor in parallel with the third inductor. In some embodiments the signal conditioning circuit also includes a second LC resonant tank circuit coupled in series along the in-home entertainment signal transmission path, where the second LC resonant tank circuit includes a fourth inductor in parallel with a fourth capacitor. In some embodiments the third resistor is in parallel with both the third inductor and the third capacitor. In some embodiments the second LC resonant tank circuit includes a fourth resistor in parallel with both the fourth inductor and the fourth capacitor. In some embodiments the second LC resonant tank circuit includes a fourth resistor in series with the fourth capacitor.

Disclosed is a method of conditioning IHE signals in a CATV system which includes the step of placing a first signal conditioning circuit in series electrical connection with an in-home entertainment signal transmission path. The first signal conditioning circuit includes one or more than one first signal conditioning circuit LC resonant shunt circuit, with each of the one or more than one first signal conditioning circuit LC resonant shunt circuits including a resistor in parallel with an inductor. The first signal conditioning circuit also includes one or more than one first signal conditioning circuit LC resonant tank circuit. The method of conditioning IHE signals in a CATV system also includes the step of placing a second signal conditioning circuit in series electrical connection with the in-home entertainment signal transmission path. The second signal conditioning circuit includes one or more than one second signal conditioning circuit LC resonant shunt circuit, with each of the one or more than one second signal conditioning circuit LC resonant shunt circuits including a resistor in parallel with both an inductor and a capacitor. The second signal conditioning circuit also includes one or more than one second signal conditioning circuit LC resonant tank circuit.

In some embodiments the method of conditioning IHE signals in a CATV system includes the step of placing a resistor in series with a capacitor in each of the one or more than one first signal conditioning circuit LC resonant tank circuits. In some embodiments the method of conditioning IHE signals in a CATV system includes the step of placing a resistor in parallel with a capacitor in each of the one or more than one second signal conditioning circuit LC resonant tank circuits. In some embodiments the first signal conditioning circuit includes three first signal conditioning circuit LC resonant shunt circuits and two first signal conditioning circuit LC resonant tank circuits. In some embodiments the second signal conditioning circuit includes three second signal conditioning circuit LC resonant shunt circuits and two second signal conditioning circuit LC resonant tank circuits.

The foregoing and other features and advantages of the present invention will be apparent from the following more detailed description of the particular embodiments of the invention, as illustrated in the accompanying drawings.

### BRIEF DESCRIPTION OF THE DRAWINGS

The features described herein can be better understood with reference to the drawings described below. The drawings are not necessarily to scale, emphasis instead generally being placed upon illustrating the principles of the invention. In the drawings, like numerals are used to indicate like parts throughout the various views.

FIG. 1 shows a simplified schematic view of a CATV network according to one embodiment of the invention;

FIG. 2 shows a simplified schematic view of CATV network device 120 according to the invention, in this embodiment a 4-way entry adapter 120;

FIG. 3 is a schematic diagram of one embodiment of signal conditioning circuit 72 according to the invention;

FIG. 4 is a schematic diagram of an embodiment of signal conditioning circuit 172 according to the invention;

FIG. 5 schematically illustrates an exemplary embodiment of CATV network device 176 in accordance with the invention;

FIG. 6 is a chart showing the insertion loss across the outlet ports of CATV network conditioning device 176 of FIG. 5; and

FIG. 7 illustrates method 350 of conditioning in-home entertainment signals in a CATV system according to the invention.

### DETAILED DESCRIPTION OF THE INVENTION

Community access television, or cable television, (CATV) networks use an infrastructure of interconnected coaxial cables, splitters, amplifiers, filters, trunk lines, cable taps, drop lines and other signal-conducting devices to supply and distribute high frequency “downstream” signals from a main signal distribution facility, known as a head-end, toward subscriber premises such as homes and businesses. The downstream signals operate the subscriber equipment, such as television sets, telephones, and computers. The typical CATV network is a two-way communication system. CATV networks also transmit “upstream” signals from the subscriber equipment back to the head-end of the CATV network. For example, upstream bandwidth may include data related to video-on-demand services, such as video requests and billing authorization. Two-way communication is also utilized when using a personal computer connected through the CATV infrastructure to the public Internet, for example when sharing photo albums or entering user account information. In yet another example, voice-over-Internet protocol (VOIP) telephones and security monitoring equipment use the CATV infrastructure and the public Internet as the communication medium for passing two-way telephone conversations and monitoring functions.

To permit simultaneous communication of upstream and downstream CATV signals and the interoperability of the subscriber equipment and the equipment associated with the CATV network infrastructure outside of subscriber premises, the downstream and upstream signals are confined to two different frequency bands. In most CATV networks the downstream frequency band, or downstream bandwidth, is within the range of 54-1002 megahertz (MHz) and the upstream frequency band, or upstream bandwidth, is within the range of 5-42 MHz.

The downstream signals are delivered from the CATV network infrastructure to the subscriber premises at a CATV entry adapter, which is also commonly referred to as an entry device, terminal adapter or a drop amplifier. The entry adapter is a multi-port device which connects at a premises entry port to a CATV drop cable from the CATV network infrastructure. The entry adapter connects at a multiplicity of other distribution ports to coaxial cables which extend throughout the subscriber premises to a cable outlet. Each cable outlet is available to be connected to subscriber equipment. Typically, most homes have coaxial cables extending to cable outlets in almost every room, because different types of subscriber equipment may be used in different rooms. For example, television sets, computers and telephone sets are commonly used in many different rooms of a home or office. The multiple distribution ports of the entry adapter deliver the downstream signals to each cable outlet and conduct the upstream signals from the subscriber equipment through the entry adapter to the drop cable and the CATV infrastructure.

In addition to television sets, computers and telephones, a relatively large number of other entertainment and multimedia devices are available for use in homes. For example, a digital video recorder (DVR) is used to record broadcast programming, still photography and moving pictures in a memory medium so that the content can be replayed on a display or television set at a later time selected by the user. As another example, computer games are also played at displays or on television sets. Such computer games may be those obtained over the Internet from the CATV network or from media played on play-back devices connected to displays or television sets. In another example, receivers of satellite-broadcast signals may be distributed for viewing or listening throughout the home. These types of devices, including the more conventional television sets, telephone sets and devices connected to the Internet by the CATV network, are generically referred to as multimedia devices.

An in-home entertainment network may be coupled to the CATV network via the same coaxial cable delivering the downstream and upstream bandwidth of the CATV system. The in-home entertainment network can be a network providing multiple streams of high definition video and gaming entertainment. Examples of in-home entertainment network technologies include Ethernet, HomePlug, Home Phoneline Networking Alliance (HPNA), Multimedia over Coax Alliance (MoCA) and 802.11n protocols. The in-home entertainment (IHE) network is coupled to the CATV network within a subscriber premises to allow the CATV network to distribute IHE signals from one multimedia device to another within the subscriber premises.

In a specific example, the in-home entertainment network may employ technology standards developed to distribute multimedia-over-coax signals within the CATV subscriber premises. Products designed to use multimedia-over-coax signals can be used to create an in-home entertainment network by interconnecting presently-known and future multimedia devices, such as set-top boxes, routers and gateways, bridges, optical network terminals, computers, gaming systems, display devices, printers, network-attached storage, and home automation such as furnace settings and lighting control.

A multimedia-over-coax network uses the in-home coaxial cable infrastructure originally established for distribution of CATV signals within the subscriber premises, principally because that coaxial cable infrastructure already exists in most homes and is capable of carrying much more information than is carried in the CATV frequency bands. A multimedia-over-coax network is established by connecting multimedia-over-coax -enabled or multimedia-over-coax interface devices at the cable outlets in the rooms of the subscriber premises. The multimedia-over-coax interface devices implement a multimedia-over-coax communication protocol which encapsulates the signals normally used by the multimedia devices within multimedia-over-coax signal packets and then communicates the multimedia-over-coax signal packets between other multimedia-over-coax interface devices connected at other cable outlets. The receiving multimedia-over-coax interface device removes the encapsulated multimedia signals from the multimedia-over-coax signal packets, and delivers the multimedia signals to the connected display, computer or other multimedia device from which the content is presented to the user.

Each multimedia-over-coax-enabled device is capable of communicating with every other multimedia-over-coax-enabled device in the in-home or subscriber premises network to deliver the multimedia content throughout the home or subscriber premises. The multimedia content that is available from one multimedia device can be displayed, played or otherwise used at a different location within the home, without having to physically relocate the originating multimedia device from one location to another within the subscriber premises. The communication of multimedia content is considered beneficial in more fully utilizing the multimedia devices present in modem homes.

Since the operation of the subscriber premises IHE network must occur simultaneously with the operation of the CATV services, the multimedia-over-coax signals utilize a frequency range different from the frequency ranges of the CATV upstream and downstream signals. A typical multimedia-over-coax frequency band is 1125-1675 MHz. A particular IHE network frequency band may includes other frequency ranges, but the 1125-1675 MHz band is of major relevance because of its principal use in establishing connections between the multimedia-over-coax interface devices within the CATV network.

Although using the in-home cable infrastructure as the communication medium substantially simplifies the implementation of the IHE network, there are certain disadvantages to doing so. One noted problem arises when multimedia-over-coax signals pass backwards through a conventional splitter en route to another multimedia-over-coax-enabled device within the network. The CATV network and the in-home cable infrastructure were originally intended for the distribution of CATV signals. The typical in-home cable infrastructure uses signal splitters to divide CATV downstream signals into multiple CATV downstream paths and to combine multiple CATV upstream signals into a single CATV upstream path. The CATV entry adapter was not originally intended to communicate multimedia-over-coax signals between its ports, as is necessary to achieve multimedia-over-coax signal communication in the IHE network. To implement the IHE network, the multimedia-over-coax signals must traverse between separate signal component legs of a signal splitter/combiner which are connected to the multiple ports.

The typical signal splitter has a high degree of signal rejection or isolation between its separate signal component legs. When the multimedia-over-coax signals traverse between the separate signal component legs of the splitter, the degree of signal rejection or isolation greatly attenuates the strength of the multimedia-over-coax signals. This it is desirable to have a system which transmits both CATV and IHE signals without attenuating or rejecting the IHE signals to a large degree.

Some IHE network communication protocols recognize the possibility of variable strength multimedia-over-coax signals and provide the capability to boost the strength of multimedia-over-coax signals to compensate for the variable strength of the multimedia-over-coax signals that would otherwise be communicated between multimedia-over-coax-enabled devices. However, boosting the strength of the multimedia-over-coax signal can result in the strength or power of the multimedia-over-coax signals being substantially greater than the strength or power of the CATV signals communicated within the subscriber premises. Consequently, the multimedia-over-coax signals have the capability of adversely affecting the proper functionality of standard CATV subscriber equipment, such as a digital video recorder or an embedded multimedia terminal adapter (eMTA). This it is desirable to have a device for use in a CATV network which conditions the IHE signals transmitted through the network such that the IHE signals will not be rejected, without adversely affecting the CATV communication occurring simultaneously on the CATV network.

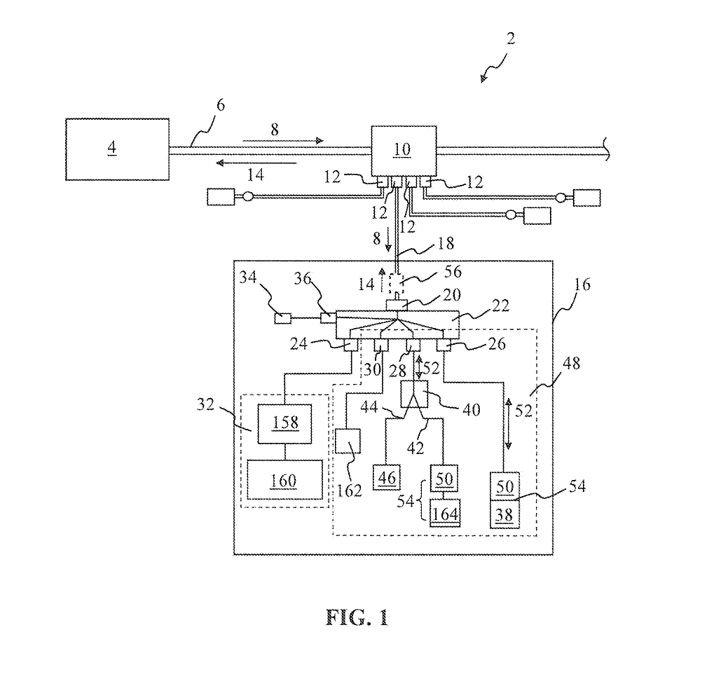

Referring to FIG. 1, a simplified schematic view of a portion of a community access television or cable television (CATV) network 2 according to one embodiment of the invention is shown, which includes a head-end facility 4 for processing and distributing signals over the network. Head-end facility 4 is typically controlled by a system operator and includes electronic equipment to receive and re-transmit video and other signals over the local cable infrastructure. One or more main distribution lines 6 carry downstream signals 8 from head-end facility 4 to cable tap 10 configured to serve a local distribution network of about 100 to 500 end users, customers, or subscribers. Cable tap 10 includes a plurality of tap ports 12 configured to carry downstream signals 8 and upstream signals 14 to each subscriber premises 16 via a drop cable 18, which may be a single coaxial cable. In one embodiment, upstream signals 14 are in the range of 5-42 MHz and the downstream signals 8 are in the range of 54-1002 MHz.

Drop cable 18 enters subscriber premises 16 and connects to a splitter having a single CATV network connection or entry port 20 and two or more outlet ports. In the disclosed example, the splitter is a 4-way CATV entry adapter 22 that includes four outlet ports 24, 26, 28, and 30. Downstream signals 8 may be delivered to a passive subscriber device 32, such as an embedded multimedia terminal adapter (eMTA) 32 through outlet port 24. An eMTA device combines a high-speed data cable modem 158 with voice-over-Internet Protocol technology to create a platform that connects analog telephones and terminal equipment (e.g., fax) to the cable operator's advanced Internet protocol communications network. Cable modem 158 provides a data interface for communicating Internet protocol packets to and from the CATV network 2, and an analog telephone adapter provides a voice over Internet protocol (VoIP) interface for analog telephone set 160. The eMTA device 32 converts between analog voice signals and packets. A lifeline telephone is a well known example of an eMTA device.

In the disclosed example, outlet port 26 conducts and receives CATV signals to and from an IHE network-enabled subscriber device, which in this embodiment is multimedia-over-coax-enabled set top box (STB) 38. Third outlet port 28 conducts downstream signals 8 to a conventional splitter 40. Downstream signals 8 are divided and distributed down a first branch 42 to another IHE network-enabled subscriber device, which in this embodiment is multimedia-over-coax-enabled digital video recorder (DVR) 164. A second branch 44 of the splitter 40 distributes the downstream CATV signals 8 to a conventional subscriber device, which in this embodiment is television set 46. Subscriber device 46 is not IHE network-enabled, meaning it is not equipped to process IHE network signals, such as multimedia-over-coax signals. Upstream CATV signals 14 sent from IHE network-enabled subscriber devices 164 and television set 46 (if any) are combined in splitter 40 and delivered out entry port 20 to main distribution line 6. Outlet port 30 distributes downstream CATV signals 8 to a conventional subscriber device, which in this embodiment is personal computer 162.

Subscriber premises 16 further includes an in-home entertainment (IHE) network 48 which, in the disclosed embodiment, is a multimedia-over-coax network which carries signals in a multimedia-over-coax frequency range from 1125 to 1675 MHz. As used herein, an IHE network carries data on existing coaxial cable infrastructure at a spectrum of frequencies or bandwidth separate from the CATV bandwidth. In that regard, the data is not limited to entertainment, and may include security information, personal information, and the like. IHE network 48 interconnects multimedia-over-coax-enabled subscriber devices such as digital video recorder 164, computers 162, data modems, computer game playing devices, television sets 46, television set-top boxes 38, and other audio and visual entertainment devices.

Network 2 shown in FIG. 1 includes optional low-pass filter 56. Low-pass filter 56 is used to block IHE signals such as the multimedia-over-coax band used in this example, from exiting subscriber network 16 and traveling to head-end 4 or other subscriber premise networks. It is not desirable to have the IHE signals 52 from one subscriber premise be transmitted outside subscriber network 16. Low-pass filter 56 will allow downstream signals 8 and upstream signals 14 to pass through low-pass filter 56, but will reject IHE signals 52, not allowing them to exit subscriber premises 16. Filter 56 is shown in dotted lines because it is optional, and can be placed in other locations. In some embodiments filter 56 is included in other network devices such as 4-way splitter 22, as will be discussed shortly.

Because conventional signal splitters are designed for the CATV band (e.g., 5 1002 MHz), they have low and non-flat isolation as well as high and non-flat insertion loss in the IHE bands, in particular in the multimedia-over-coax band of 1125 to 1675 MHz. Additionally, inherent losses in coaxial cables also increase with increasing frequency, resulting in roll-off (e.g., non-flat insertion loss) characteristics in the multimedia-over-coax band. Therefore, multimedia-over-coax signals 52 transmitted between the separate signal component legs of entry adapter 22 or splitter 40 are attenuated in a non-flat fashion or the isolation between the splitter legs will be degraded, which may be undesirable. Some IHE network communication protocols recognizes the attenuation and boost the strength of IHE signals to compensate. However, the boost in signal strength has the adverse result of creating “noise” seen by the non-IHE-enabled subscriber devices. The non-IHE-enabled subscriber devices such as eMTA device 32 or television 46 and cable modem 158 may become overloaded by the noise and may cease to function properly. In the situation wherein eMTA 32 is a lifeline telephone system transmitting security signals to a monitoring company, this situation would be highly undesirable.

Furthermore, IHE signals 52 received by the IHE-enabled subscriber devices may not be at the same power level across the entire multimedia-over-coax frequency band, due to a phenomenon known as roll-off. When the controller increases the signal strength of the multimedia-over-coax signals, the end result will still be uneven, which may adversely affect the performance of the IHE device.

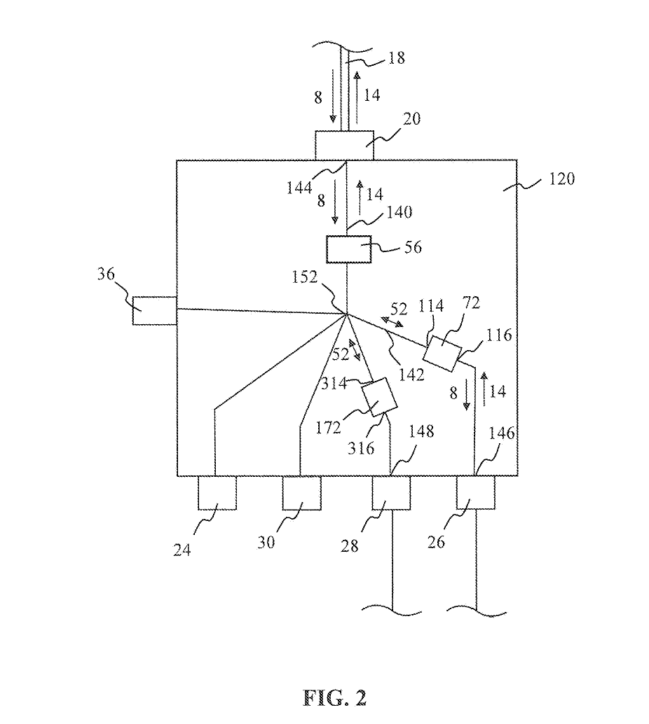

FIG. 2 shows CATV network device 120 according to the invention which overcomes these discussed deficiencies. CATV network device 120 is a 4-way CATV splitter similar to device 22 shown in FIG. 1. CATV network device 120 can be used in place of entry device 22 in network 2 of FIG. 1. CATV network device 120 includes a CATV signal transmission path 140, which transmits CATV signals 8 and 14 between entry node 144 and splitter node 152. Entry node 144 is positioned at entry port 20 of device 120. Splitter node 152 is positioned in device 120 where path 140 is split into multiple signal transmission paths.

CATV network device 120 includes an in-home entertainment signal transmission path 142, which transmits IHE signals 52 between outlet port node 146 and outlet port node 148. Outlet port node 146 is positioned at outlet port 26. Outlet port node 148 is positioned at outlet port 28.

CATV signal transmission path 140 includes low-pass filter 56, which passes frequencies in the CATV upstream and downstream bands, and rejects frequencies in the IHE multimedia-over-coax frequency band of 1125 to 1675 MHz. Low-pass filter 56 can be any type of filter which conducts CATV upstream signals 14 in a first frequency range, which is the CATV upstream signal 14 frequency range of 5-42 MHz, also conducts CATV downstream signals 8 in a second frequency range, which is the CATV downstream signal 8 frequency range of 54-1002 MHz, and rejects in-home entertainment signals 52 in a third frequency range, which in this embodiment is the multimedia-over-coax frequency range of 1125 to 1675 MHz. In this way CATV network device 120 includes a CATV signal transmission path 140 which conducts CATV downstream signals 8 in a first frequency range from 54-1002 MHz. CATV signal transmission path 140 also conducts CATV upstream signals 14 in a second frequency range of 5-42 MHz. CATV signal transmission path 140 rejects IHE signals 52 in a third frequency range that is different from the first frequency range and the second frequency range. In this embodiment IHE signals 52 are in a third frequency range that is 1125-1675 MHz. CATV signal transmission path 140 rejects IHE signals 52 because CATV signal transmission path 140 includes low-pass filter 56. In this embodiment of device 120, filter 56 is placed along CATV signal transmission path 140, instead of along signal transmission path 18 as shown in FIG. 1. Filter 56 rejects in-home entertainment signals and keeps IHE signals from exiting subscriber premises 16.

In-home entertainment signal transmission path 142 transmits CATV signals 8 and 14, and IHE signals 52, between nodes 146 and 148. IHE signal transmission path 142 conducts CATV downstream signals 8 in the first frequency range of 54-1002 MHz from node 146 to node 148. IHE signal transmission path 142 conducts CATV upstream signals 14 in the second frequency range of 5-42 MHz from node 146 to node 148. IHE signal transmission path 142 conducts IHE signals 52 in the third frequency range of 1125-1675 MHz from node 146 to node 148.

In-home entertainment signal transmission path 142 includes at least one signal conditioning circuit 72 or 172, where signal conditioning circuits 72 and 172 each include at least one LC resonant shunt circuit and at least one LC resonant tank circuit, as will be described shortly. In some embodiments IHE signal transmission path 142 includes one signal conditioning circuit 72 or 172. In some embodiments IHE signal transmission path 142 includes a signal conditioning circuit according to the invention other than circuit 72 or 172. In some embodiments IHE signal transmission path 142 includes two signal conditioning circuits, such as signal conditioning circuit 72 or signal conditioning circuit 172 or one or more other signal conditioning circuit according to the invention. Signal conditioning circuit 72 and 172 according to the invention condition IHE signals 52 such that their response within IHE network 48 is flat. Signal conditioning circuit 72 and 172 according to the invention equalize IHE signals 52 such that their response within IHE network 48 does not roll off, as explained in more detail below. In some embodiments IHE signals 52 conducted along IHE signal transmission path 142 are attenuated an amount in the range of −1 dB to −30 dB in response to passing through signal conditioning circuits 72 and 172. In some embodiments IHE signal 52 conducted along IHE signal transmission path 142 are attenuated an amount in the range of −15 dB to −20 dB in response to passing through signal conditioning circuits 72 and 172.

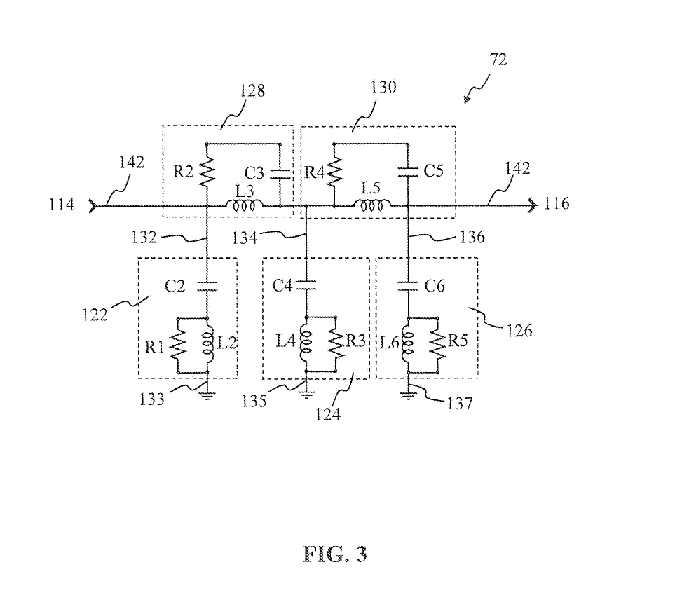

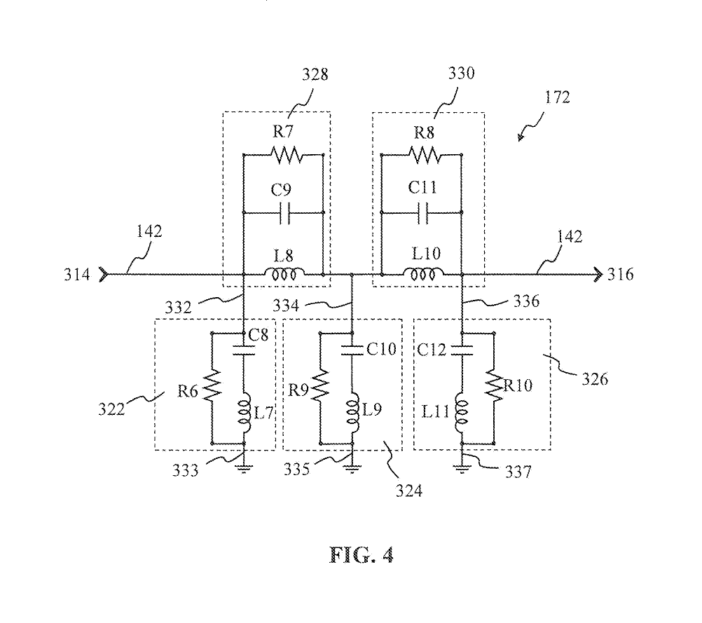

FIG. 3 and FIG. 4 show schematic diagrams of two examples of embodiments of signal condition circuits according to the invention. FIG. 3 shows a schematic embodiment of signal conditioning circuit 72 according to the invention of FIG. 2. FIG. 4 shows a schematic embodiment of signal conditioning circuit 172 according to the invention of FIG. 2.

Signal conditioning circuit 72 according to the invention includes at least one LC resonant shunt circuit. An LC resonant shunt circuit is a circuit with at least one inductor and at least one capacitor, where the circuit connects a signal transmission path to a current return path. In other words, the LC resonant shunt circuit provides an alternative path to ground, other than the main signal transmission path, and includes at least one inductor and at least one capacitor. In the embodiment shown in FIG. 3, signal conditioning circuit 72 includes 3 LC resonant shunt circuits, first LC resonant shunt circuit 122, second LC resonant shunt circuit 124, and third LC resonant shunt circuit 126. In some embodiments signal conditioning circuit 72 includes two LC resonant shunt circuits. In some embodiments signal conditioning circuit 72 includes more than three LC resonant shunt circuits. In some embodiments signal conditioning circuit 72 includes two LC resonant tank circuits. In some embodiments signal conditioning circuit 72 includes more than three LC resonant tank circuits.

Signal conditioning circuit 72 includes IHE signal transmission path 142 in this embodiment. In some embodiments signal conditioning circuit 72 includes signal transmission paths other than signal transmission path 142. Signal conditioning circuit 72 includes IHE signal transmission path 142 in this embodiment because signal conditioning circuit 72 is placed along IHE signal transmission path 142 in device 120 as shown in FIG. 2. IHE signal transmission path 142 enters and exits signal conditioning circuit 72 at nodes 114 and 116. IHE signals 52 are conducted along IHE signal transmission path 142 in both directions as they traverse IHE signal transmission path 142 in device 120.

Signal conditioning circuit 72 includes first LC resonant shunt circuit 122, which has first LC resonant shunt circuit first end 132 electrically coupled to IHE signal transmission path 142, and first LC resonant shunt circuit second end 133 coupled to a current return path. First LC resonant shunt circuit 122 includes first capacitor C2 in series electrical connection with first inductor L2. First LC resonant shunt circuit 122 also includes first resistor R1, which is in parallel electrical connection with first inductor L2. In some embodiments signal conditioning circuit 72 includes other components. Signal conditioning circuit 72 adds resistance in parallel or series with filter components to control the notch depth and 3 dB bandwidth of each resonant section of a filter. In effect and contrary to convention, the loaded Q factor of the filter circuit is decreased, thereby softening the notch depth and changing the response of the filter in the IHE network band of frequencies. Controlling the level of the in-home entertainment signals 52 solves the problem of overloading the non-multimedia-over-coax-enabled subscriber devices and eliminates roll-off in the multimedia-over-coax band of frequencies.

In some embodiments of first LC resonant shunt circuit 122, first resistor R1 is in parallel with both first inductor L2 and first capacitor C2, as shown in LC resonant circuit element 322, 324, and 326 in FIG. 4. In some embodiments of first LC resonant shunt circuit 122, first LC resonant shunt circuit 122 includes other elements. It is to be understood that any form or type of electrical components can be used in circuit 122 including discrete components, integrated components, and/or components other than resistors, inductors, and capacitors which provide equivalent resistance, capacitance or inductance to the circuit depicted.

Signal conditioning circuit 72 according to the invention includes at least one LC resonant tank circuit. Signal conditioning circuit 72 as shown in FIG. 3 includes first LC resonant tank circuit 128 coupled in series along IHE signal transmission path 142. An LC resonant tank circuit is an electrical circuit that includes at least one inductor and at least one capacitor that is coupled in series along a signal transmission path. First LC resonant tank circuit 128 includes second inductor L3 and second capacitor C3. First LC resonant tank circuit 128 includes second resistor R2 in series with second capacitor C3 in the embodiment shown in FIG. 3. In some embodiments first LC resonant tank circuit 128 does not include second resistor R2. In some embodiments first LC resonant tank circuit 128 includes second resistor R2 in parallel with second capacitor C3 and second inductor L3, as shown in LC resonant tank circuit 328 and 330 in FIG. 4.

In some embodiments of signal conditioning circuit 72, signal conditioning circuit 72 includes only first LC resonant shunt circuit 122, and first LC resonant tank circuit 128. In some embodiments of signal conditioning circuit 72, first LC resonant tank circuit 128 does not include second resistor R2. In some embodiments of signal conditioning circuit 72, first LC resonant tank circuit 128 includes second resistor R2 in series with second capacitor C3 as shown. In some embodiments of signal conditioning circuit 72, first LC resonant tank circuit 128 includes second resistor R2 in parallel with second capacitor C3, similar to LC resonant tank circuits 328 and 330 in FIG. 4.

In the embodiment of signal conditioning circuit 72 shown in FIG. 3, signal conditioning circuit 72 includes second LC resonant shunt circuit 124. Second LC resonant shunt circuit 124 includes second LC resonant shunt circuit first end 134 coupled to IHE signal transmission path 142, and second LC resonant shunt circuit second end 135 coupled to a current return path. Second LC resonant shunt circuit 124 in this embodiment includes third inductor L4 in series with third capacitor C4. Second LC resonant shunt circuit 124 in this embodiment also includes third resistor R3 in parallel with third inductor L4. In some embodiments second LC resonant shunt circuit 124 has third resistor R3 in parallel with both third inductor L4 and third capacitor C4. In some embodiments second LC resonant shunt circuit 124 includes other elements.

In the embodiment of signal conditioning circuit 72 shown in FIG. 3, first LC resonant tank circuit 128 is coupled in series along IHE signal transmission path 142 between first LC resonant shunt circuit first end 132 and second LC resonant shunt circuit first end 134, but the invention is not limited in this aspect. In some embodiments other electrical interconnection methods are used to interconnect first LC resonant shunt circuit 122, first LC resonant tank circuit 128, and second LC resonant shunt circuit 124.

In the embodiment of signal conditioning circuit 72 shown in FIG. 3, signal conditioning circuit 72 includes second LC resonant tank circuit 130. Second LC resonant tank circuit 130 is coupled in series along IHE signal transmission path 142. Second LC resonant tank circuit 130 includes fourth inductor L5 and fourth capacitor C5. In the embodiment of second LC resonant tank circuit 130 shown in FIG. 3, second LC resonant tank circuit 130 includes fourth resistor R4 in series with fourth capacitor C5. In some embodiments, second LC resonant tank circuit 130 does not include fourth resistor R4. In some embodiments, second LC resonant tank circuit 130 includes fourth resistor R4 in parallel with both fourth inductor L5 and fourth capacitor C5. In some embodiments, second LC resonant tank circuit 130 includes other elements.

In the embodiment of signal conditioning circuit 72 shown in FIG. 3, signal conditioning circuit 72 includes third LC resonant shunt circuit 126. Third LC resonant shunt circuit 126 includes third LC resonant shunt circuit first end 136 coupled to IHE signal transmission path 142, and third LC resonant shunt circuit second end 137 coupled to a current return path. Third LC resonant shunt circuit 126 includes fifth inductor L6 and fifth capacitor C6. In the embodiment of signal conditioning circuit 72 shown in FIG. 3, signal conditioning circuit 72 includes fifth resistor R5 in parallel with fifth inductor L6. In some embodiments of signal conditioning circuit 72, fifth resistor R5 is in parallel with both fifth inductor L6 and fifth capacitor C6. In some embodiments signal conditioning circuit 72 includes other components.

It is to be understood that any form or type of electrical components can be used in circuits 122, 124, 126, 128, and 130, including discrete components, integrated components, and/or components or circuits other than resistors, inductors, and capacitors which provide equivalent resistance, capacitance or inductance to the circuit depicted.

In the embodiment of signal conditioning circuit 72 shown in FIG. 3, first LC resonant tank circuit 128 is coupled in series along IHE signal transmission path 142 between first LC resonant shunt circuit first end 132 and second LC resonant shunt circuit first end 134, and second LC resonant tank circuit 130 is coupled in series along IHE signal transmission path 142 between second LC resonant shunt circuit first end 134 and third LC resonant shunt circuit first end 136, but the invention is not limited in this aspect. In some embodiments other electrical interconnection methods are used to interconnect first LC resonant shunt circuit 122, first LC resonant tank circuit 128, second LC resonant shunt circuit 124, second LC resonant tank circuit 130, and third LC resonant tank circuit 130.

Signal conditioning circuit 72 includes three LC resonant shunt circuits, 122, 124, and 126, each comprising an inductor/capacitor pair in series (e.g., L2/C2, L4/C4 and L6/C6). Resistance added in parallel to the inductors L2, L4 and L6 forms a “lossy” low pass filter that does not reject the in-home network band of frequencies, but rather attenuates them to an acceptable level allowing them to pass between nodes 146 and 148 of FIG. 2. In one example, the IHE network band of frequencies are attenuated to a level less than −30 dB.

In contrast, a typical low-pass filter resonant shunt circuit comprising circuits L2/C2, L4/C4 and L6/C6 without resistors R1, R3 and R5 would have a deep notch and reject the in-home network band of frequencies by applying −40 dB or more of attenuation.

In the embodiment of signal conditioning circuit 72 shown in FIG. 3, resistance is added in series to the capacitor of the capacitor/inductor elements of LC resonant tank circuits 128 and 130 of signal conditioning circuit 72. In the illustrated example, resistors R2 and R4 are added in series to capacitors C3 and C5, respectively, to equalize or flatten the multimedia-over-coax signal frequency passband slope (e.g., tilt). Thus signal conditioning circuit 72 conducts IHE signals 52 from node 114 to node 116 with a reasonable amount of attenuation instead of rejecting these signals, and signal conditioning circuit 72 equalizes the response in the multimedia-over coax frequency band to flatten the response in this band. This reduces the need to amplify the multimedia-over-coax signal strength, and improves the frequency response of those signals 52.

FIG. 4 shows a schematic embodiment of signal conditioning circuit 172 according to the invention of FIG. 2. Signal conditioning circuit 172 according to the invention includes at least one LC resonant shunt circuit, and at least one LC resonant tank circuit. Signal conditioning circuit 172 includes IHE signal transmission path 142 in this embodiment. In some embodiments signal conditioning circuit 172 includes signal transmission paths other than IHE signal transmission path 142. Signal conditioning circuit 172 includes IHE signal transmission path 142 in this embodiment because signal conditioning circuit 172 is placed along IHE signal transmission path 142 in device 120 as shown in FIG. 2. IHE signal transmission path 142 enters and exits signal conditioning circuit 172 at nodes 314 and 316 as they travel along IHE signal transmission path 142 from node 146 to node 148. IHE signals 52 are conducted along IHE signal transmission path 142 in both directions as they traverse IHE signal transmission path 142 in device 120.

Signal conditioning circuit 172 includes first LC resonant shunt circuit 322, which has first LC resonant shunt circuit first end 332 electrically coupled to IHE signal transmission path 142, and first LC resonant shunt circuit second end 333 coupled to a current return path. First LC resonant shunt circuit 322 includes first capacitor C8 in series electrical connection with first inductor L7. First LC resonant shunt circuit 322 also includes first resistor R6, which is in parallel electrical connection with first capacitor C8 and first inductor L7. In some embodiments signal conditioning circuit 172 includes other components.

Signal conditioning circuit 172 adds resistance in parallel or series with filter components to control the notch depth and 3 dB bandwidth of each resonant section of a filter. In effect and contrary to convention, the loaded Q factor of the filter circuit is decreased, thereby softening the notch depth and changing the response of the filter in the IHE network band of frequencies. Controlling the level of the in-home entertainment signals 52 solves the problem of overloading the non-multimedia-over-coax-enabled subscriber devices and eliminates roll-off in the multimedia-over-coax band of frequencies.

In some embodiments of first LC resonant shunt circuit 322, first resistor R6 is in parallel with first inductor L7, as shown in LC resonant circuit element 122, 124, and 126 in FIG. 3. In some embodiments of first LC resonant shunt circuit 322, first LC resonant shunt circuit 322 includes other elements.

Signal conditioning circuit 172 also includes first LC resonant tank circuit 328 coupled in series along IHE signal transmission path 142. First LC resonant tank circuit 328 includes second inductor L8 and second capacitor C9. First LC resonant tank circuit 328 includes second resistor R7 in parallel with second capacitor C9 and second inductor L8 in the embodiment shown in FIG. 4. In some embodiments first LC resonant tank circuit 328 does not include second resistor R7. In some embodiments first LC resonant tank circuit 328 includes second resistor R7 in series with second capacitor C9, as shown in LC resonant tank circuit 128 and 130 in FIG. 3.

In the embodiment of signal conditioning circuit 172 shown in FIG. 4, signal conditioning circuit 172 includes second LC resonant shunt circuit 324. Second LC resonant shunt circuit 324 includes second LC resonant shunt circuit first end 334 coupled to IHE signal transmission path 142, and second LC resonant shunt circuit second end 335 coupled to a current return path. Second LC resonant shunt circuit 324 in this embodiment includes third inductor L9 in series with third capacitor C10. Second LC resonant shunt circuit 324 in this embodiment also includes third resistor R9 in parallel with third inductor L4 and third capacitor C10. In some embodiments second LC resonant shunt circuit 324 has third resistor R9 in parallel with third inductor L9. In some embodiments second LC resonant shunt circuit 124 includes other elements.

In the embodiment of signal conditioning circuit 172 shown in FIG. 4, first LC resonant tank circuit 328 is coupled in series along IHE signal transmission path 142 between first LC resonant shunt circuit first end 332 and second LC resonant shunt circuit first end 334, but the invention is not limited in this aspect. In some embodiments other electrical interconnection methods are used to interconnect first LC resonant shunt circuit 322, first LC resonant tank circuit 328, and second LC resonant shunt circuit 324.

In the embodiment of signal conditioning circuit 172 shown in FIG. 4, signal conditioning circuit 172 includes second LC resonant tank circuit 330. Second LC resonant tank circuit 330 is coupled in series along IHE signal transmission path 142. Second LC resonant tank circuit 330 includes fourth inductor L10 and fourth capacitor C11. In the embodiment of second LC resonant tank circuit 330 shown in FIG. 4, second LC resonant tank circuit 330 includes fourth resistor R8 in parallel electrical connection with fourth capacitor C11 and fourth inductor L10. In some embodiments, second LC resonant tank circuit 330 does not include fourth resistor R8. In some embodiments, second LC resonant tank circuit 330 includes fourth resistor R8 in series electrical connection with fourth capacitor C11. In some embodiments, second LC resonant tank circuit 330 includes other elements.

In the embodiment of signal conditioning circuit 172 shown in FIG. 4, signal conditioning circuit 172 includes third LC resonant shunt circuit 326. Third LC resonant shunt circuit 326 includes third LC resonant shunt circuit first end 336 coupled to IHE signal transmission path 142, and third LC resonant shunt circuit second end 337 coupled to a current return path. Third LC resonant shunt circuit 326 includes fifth inductor L11 and fifth capacitor C 12. In the embodiment of signal conditioning circuit 172 shown in FIG. 4, third LC resonant shunt circuit 326 includes fifth resistor R10 in parallel with fifth inductor L11 and fifth capacitor C12. In some embodiments of third LC resonant shunt circuit 326, fifth resistor R10 is in parallel with fifth inductor L6. In some embodiments third LC resonant shunt circuit 326 includes other components.

In the embodiment of signal conditioning circuit 172 shown in FIG. 4, second LC resonant tank circuit 330 is coupled in series along IHE signal transmission path 142 between second LC resonant shunt circuit first end 334 and third LC resonant shunt circuit first end 336, but the invention is not limited in this aspect. In some embodiments other electrical interconnection methods are used to interconnect second LC resonant shunt circuit 324, second LC resonant tank circuit 330, and third LC resonant shunt circuit 326.

It is to be understood that any form or type of electrical components can be used in circuits 322, 324, 326, 328, and 330, including discrete components, integrated components, and/or components or circuits other than resistors, inductors, and capacitors which provide equivalent resistance, capacitance or inductance to the circuit depicted.

Signal conditioning circuit 172 includes two LC resonant tank circuits, 328 and 330, each comprising an inductor/capacitor pair in parallel (e.g., L8/C9 and L10/C11). Resistance (e.g., R7 and R8) is added in parallel to the tanks to form another embodiment of a “lossy” low pass filter that does not reject the IHE network band of frequencies, but rather attenuates them to an acceptable level allowing them to pass between the nodes 146 and 148, for example, of FIG. 2. In another example of adding resistance in parallel to the capacitor/inductor elements of the shunt legs, resistors R6, R9, and R10 are added in parallel to inductor/capacitor pairs L7/C8, L9/C10, and L11/C12, respectively, of the LC resonant shunt circuit 322, 324 and 326 of signal conditioning circuit 172 to flatten the passband slope (e.g., tilt) in the IHE signal frequency band, for example in the multimedia-over coax frequency band of 1125-1675 MHz.

In the embodiment of CATV device 120 shown in FIG. 2, IHE signal transmission path 142 conducts IHE signals 52 between node 146 and node 148. CATV device 120 includes first signal conditioning circuit 72 in series electrical connection with IHE signal transmission path 142, specifically in series electrical connection with IHE signal transmission path 142 between node 146 and node 152. In this way CATV device 120 includes IHE signal transmission path 142 which includes at least one signal conditioning circuit 72. Signal conditioning circuit 72 in the embodiment shown in FIG. 3 includes three LC resonant shunt circuits 122, 124, and 126, and two LC resonant tank circuits 128 and 130. In device 120 according to the invention, signal conditioning circuit 72 includes at least one LC resonant shunt circuit, and at least one LC resonant tank circuit. In some embodiments device 120 includes signal conditioning circuit 72 with two or more LC resonant shunt circuits and two or more LC resonant tank circuits. In some embodiments device 120 includes signal conditioning circuit 72 with other elements.

CATV device 120 of FIG. 2 includes second signal conditioning circuit 172 in series electrical connection with IHE signal transmission path 142, specifically in series electrical connection with IHE signal transmission path 142 between node 152 and node 148. Signal conditioning circuit 172 in the embodiment shown in FIG. 4 includes three LC resonant shunt circuits 322, 324, and 326, and two LC resonant tank circuits 328 and 330. In device 120 according to the invention, signal conditioning circuit 172 includes at least one LC resonant shunt circuit, and at least one LC resonant tank circuit. In some embodiments device 120 includes signal conditioning circuit 172 with two or more LC resonant shunt circuits and two or more LC resonant tank circuits. In some embodiments device 120 includes signal conditioning circuit 172 with other elements.

Signal conditioning circuits 72 and 172 attenuate and equalize, or flatten, the response of IHE signals 52 as they are conducted along IHE signal transmission path 142. In some embodiments IHE signals in the multimedia-over-coax frequency range of 1125-1675 MHz are attenuated an amount in the range of −1 dB to −30 db in response to passing through signal conditioning circuits 72 and 172. In some embodiments IHE signal in the multimedia-over-coax frequency range of 1125-1675 MHz are attenuated an amount in the range of −15 dB to −20 dB in response to passing through signal conditioning circuits 72 and 172.

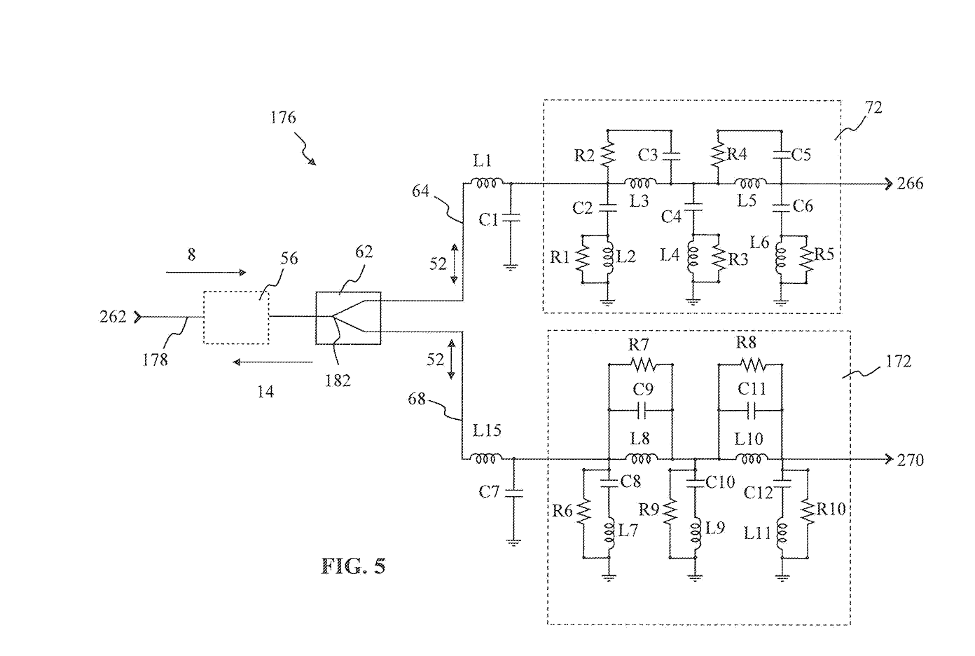

Referring to FIG. 5, CATV network device 176 according to the present invention is shown. In the disclosed embodiment CATV network device 176 is a two-way splitter adapted for use as a port of entry (POE) filter. However, CATV network conditioning device 176 may also be realized in any splitter, such as that found in the location of splitter 40 in FIG. 1, or in a four-way splitter such as entry adapter 22 of FIG. 1. In other embodiments, CATV network device 176 may be a stand-alone device adapted for coupling to a conventional splitter output port.

CATV network device 176 includes a provider content input port 262 which may be a standard female coaxial port configured to pass downstream signals 8 and upstream signals 14 from CATV network 2, for example. In the embodiment shown CATV network 2 carries downstream signals 8 in the 54-1002 MHz range, and also carries upstream signals 14 in the 5-42 MHz range, represented in FIG. 5 as arrows pointing in both directions.

Because CATV network device 176 is adapted for use as a POE filter, CATV network device 176 further includes an optional low pass filter 56 to prevent in-home entertainment signals 52 from passing upstream to main distribution line 6. Low-pass filter 56 may be integrated within the splitter as shown, or may be realized as a separate in-line filter installed upstream of CATV network device 176. Low-pass filter 56 includes filter circuitry that passes downstream and upstream CATV signals 8 and 14, but rejects in-home entertainment network bandwidth, such as multimedia-over-coax signals 52 in the frequency range of 1125-1675 MHz signals. Thus, low-pass filter 56 effectively prohibits IHE network signals from passing beyond in-home entertainment network 48.

CATV network device 176 further includes splitter portion 62 that divides the incoming signals and distributes them down a first output path 64 to a first output port node 266 and down a second output path 68 to a second output port node 270. Signal transmission paths 64 and 68, also conduct IHE signals 52 between first output port node 266 and second output port node 270.

CATV network device 176 includes CATV signal transmission path 178, which transmits CATV signals 8 and 14 between input port node 262 and node 182. In the embodiment shown in FIG. 5, CATV signal transmission path 178 includes low-pass filter 56, which passes frequencies in the CATV upstream and downstream bands, and rejects frequencies in the IHE multimedia-over-coax frequency band of 1125 to 1675 MHz. In this embodiment low-pass filter 56 conducts CATV upstream signals 14 in a first frequency range, which is the CATV upstream signal 14 frequency range of 5-42 MHz, also conducts CATV downstream signals 8 in a second frequency range which is the CATV downstream signal 8 frequency range of 54-1002 MHz, and rejects in-home entertainment signals 52 in a third frequency range which in this embodiment is the multimedia-over-coax frequency range of 1125 to 1675 MHz. In this way CATV network device 176 includes CATV signal transmission path 178 which conducts CATV downstream signals 8 in a first frequency range from 54-1002 MHz. CATV signal transmission path 178 also conducts CATV upstream signals 14 in a second frequency range of 5-42 MHz. CATV signal transmission path 178 rejects IHE signals 52 in a third frequency range that is different from the first frequency range and the second frequency range. In this embodiment signals 52 are in a third frequency range that is 1125-1675 MHz. CATV signal transmission path 178 rejects IHE signals 52 because CATV signal transmission path 140 includes low-pass filter 56. In this embodiment of device 176, filter 56 is placed along CATV signal transmission path 178, where filter 56 rejects in-home entertainment signals and keeps IHE signals from exiting subscriber premises 16.

In-home entertainment signal transmission path 64 transmits CATV signals 8 and 14, and IHE signals 52, between output port node 266 and node 182 in splitter 62. IHE signal transmission path 64 conducts CATV downstream signals 8 in the first frequency range of 54-1002 MHz from node 266 to node 182. IHE signal transmission path 64 conducts CATV upstream signals 14 in the second frequency range of 5-42 MHz from node 266 to node 182. IHE signal transmission path 64 conducts IHE signals 52 in the third frequency range of 1125-1675 MHz from node 266 to node 182.

In-home entertainment signal transmission path 68 transmits CATV signals 8 and 14, and IHE signals 52, between output port node 270 and node 182 in splitter 62. IHE signal transmission path 68 conducts CATV downstream signals 8 in the first frequency range of 54-1002 MHz from node 270 to node 182. IHE signal transmission path 68 conducts CATV upstream signals 14 in the second frequency range of 5-42 MHz from node 270 to node 182. IHE signal transmission path 68 conducts IHE signals 52 in the third frequency range of 1125-1675 MHz from node 270 to node 182

CATV network device 176 further includes signal conditioning circuit 72 of FIG. 3 that controls the level of in-home entertainment signals 52 communicating between the output port nodes 266 and 270. Signal conditioning circuit 72 adds resistance in parallel or series with filter components to control the notch depth and 3 dB bandwidth of each resonant section of a filter, as described earlier with regard to signal conditioning circuit 72. In effect and contrary to convention, the loaded Q factor of the filter circuit is decreased, thereby softening the notch depth and changing the response of the filter in the in-home entertainment signal band of frequencies. Controlling the level of the in-home entertainment signals 52 solves the problem of overloading the non-multimedia-over-coax-enabled subscriber devices and eliminates roll-off in the multimedia-over-coax band of 1125-1675 MHz.

In the embodiments of CATV network device 176 shown in FIG. 5, signal conditioning circuit 72 is in series electrical connection with IHE signal transmission path 64. Signal conditioning circuit 72 includes resistance in parallel to the filter components in the LC resonant shunt circuits 122, 124, and 126 (see FIG. 3). Signal conditioning circuit 72 includes three LC resonant shunt circuits, each comprising an inductor/capacitor pair in series (e.g., L2/C2, L4/C4 and L6/C6). Resistance added in parallel to the inductors L2, L4 and L6 forms a “lossy” low pass filter that does not reject the IHE network band of frequencies, but rather attenuates them to an acceptable level, allowing them to pass between node 266 and 270. In one example, IHE network band of frequencies are attenuated to a level less than −30 dB in response to passing through signal conditioning circuits 72 and 172.

In contrast, a typical low-pass filter resonant shunt circuit comprising circuits L2/C2, L4/C4 and L6/C6 without resistors R1, R3 and R5 would have a deep notch and reject the in-home entertainment band of frequencies by applying −40 dB or more of attenuation.

In some embodiments, resistance may be added in series to the capacitor of the capacitor/inductor elements of the LC resonant tank circuits of signal conditioning circuit 72. In the illustrated example, resistors R2 and R4 are added in series to capacitors C3 and C5, respectively, in LC resonant tank circuits 128 and 130 (see FIG. 3) to flatten the response passband slope (e.g., tilt) in the IHE signal frequency band.

CATV network device 176 further includes signal conditioning circuit 172 of FIG. 4 that controls the level of in-home entertainment signals 52 communicating between output port nodes 266 and 270. Signal conditioning circuit 172 adds resistance in parallel or series with filter components to control the notch depth and 3 dB bandwidth of each resonant section of a filter, as described earlier with regard to signal conditioning circuit 172 of FIG. 4. In effect and contrary to convention, the loaded Q factor of the filter circuit is decreased, thereby softening the notch depth and changing the response of the filter in the in-home network band of frequencies. Controlling the level of the in-home entertainment signals 52 solves the problem of overloading the non -multimedia-over-coax-enabled subscriber devices and eliminates roll-off in the multimedia-over-coax band of 1125-1675 MHz.

In the embodiment of CATV network device 176 shown in FIG. 5, IHE signal transmission path 68 includes signal conditioning circuit 172. Signal conditioning circuit 172 includes two LC resonant tank circuits, 328 and 330 (see FIG. 4), each comprising an inductor/capacitor pair in parallel (e.g., L8/C9 and L10/C11). Resistance (e.g., R7 and R8) is added in parallel to the tanks to form another embodiment of a “lossy” low pass filter that does not reject the IHE network band of frequencies, but rather attenuates them to an acceptable level allowing them to pass between ports 266 and 270. In another example of adding resistance in parallel to the capacitor/inductor elements of the LC resonant shunt circuits, resistors R6, R9, and R10 are added in parallel to inductor/capacitor pairs L7/C8, L9/C10, and L11/C12, respectively, of the signal conditioning circuit 172 to flatten the frequency response passband slope (e.g., tilt) in the in-home entertainment frequency band. Each signal path 64 and 68 further includes inductor/capacitor arrangements such as L1/C1 and L15/C7 in this embodiment to control the matching between signal conditioning circuits 72 and 172.

CATV network device 176 shown in FIG. 5 is one example of a CATV network device according to the invention. In some embodiments two signal conditioning circuits 72 are used in CATV network device 176. In some embodiments two signal conditioning circuits 172 are used in CATV network device 176. In some embodiments signal conditioning circuits 72 and/or 172 used in CATV network device 176 are different embodiments than those shown in the figures. In some embodiments the signal conditioning circuits used in CATV network device 176 include other elements. In some embodiments CATV network device 176 includes other elements than those shown in the figures. In some embodiments other signal conditioning circuits are used in CATV network device 176 according to the invention.

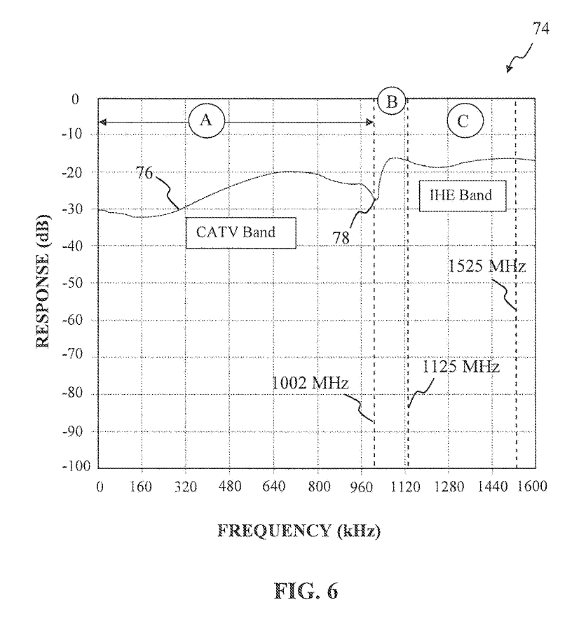

FIG. 6 is a chart 74 illustrating frequency response 76 (e.g., insertion loss) of CATV network device 176 from the first output port node 266 to the second output port node 270. Chart 74 is divided into three frequency ranges; the first range is the entire CATV bandwidth (e.g., 5-1002 MHz), denoted in the segment labeled “A”, which includes CATV signals 8 and 14. The second range is a transition zone (e.g., 1002- 1125 MHz) that does not carry either the CATV upstream or downstream signals or in-home entertainment signals, denoted in the segment labeled “B”. The third range is the in-home entertainment network range of frequencies, in this embodiment the multimedia-over-coax band from 1125 to 1675 MHz, denoted in the segment labeled “C”. As can be appreciated with reference to chart 74, CATV network device 176 adapted as a splitter provides excellent port-to-port isolation in the CATV range of frequencies: generally greater than −20 dB. The notch depth 78 in the transition zone is shallow, allowing for a flat response in the multimedia-over-coax band of frequencies. The insertion loss in the multimedia-over-coax band is approximately −18 dB, which provides good attenuation of the multimedia-over-coax signals 52 so as to prevent overloading non-multimedia-over-coax devices in the subscriber premises.

In contrast, a conventional splitter without signal conditioning circuits 72 and 172 of the present invention would provide approximately the same level of port-to-port isolation in the CATV range of frequencies, but would exhibit roll-off in the multimedia-over-coax band of frequencies.

One advantage provided by the CATV network devices 120 and 176 is that performance is not degraded in subscriber devices that are not IHE network-enabled. In other words, non-IHE network-enabled devices will not be overwhelmed by in-home entertainment signals, which may be amplified within the network. For example, referring back to FIG. 1, conventional splitter 40 distributes CATV signals and, in one embodiment, multimedia-over-coax signals. In order to improve the multimedia-over-coax signals that are degraded by traversing backwards through entry adapter 22, the IHE signal protocol may amplify the signal from set-top box 38 to multimedia-over-coax-enabled digital video recorder 164. However, the amplified signal also transmits to the non-multimedia-over-coax-enabled television 46, and the amplified signal may interfere with the CATV signals. Replacing conventional splitter 40 or conventional entry adapter 22 with the disclosed CATV network device 120 or CATV network device 176 (minus low-pass filter 60 where appropriate) attenuates the response in the multimedia-over-coax band of frequencies. In one example, the response is flattened to −18 dB.

Another advantage provided by CATV network devices 120 and 176 is that the frequency response is flattened (equalized) in the in-home entertainment range of frequencies, which improves amplification. In other words, amplification by an IHE protocol will result in a uniform strength of signal across the IHE spectrum of frequencies.

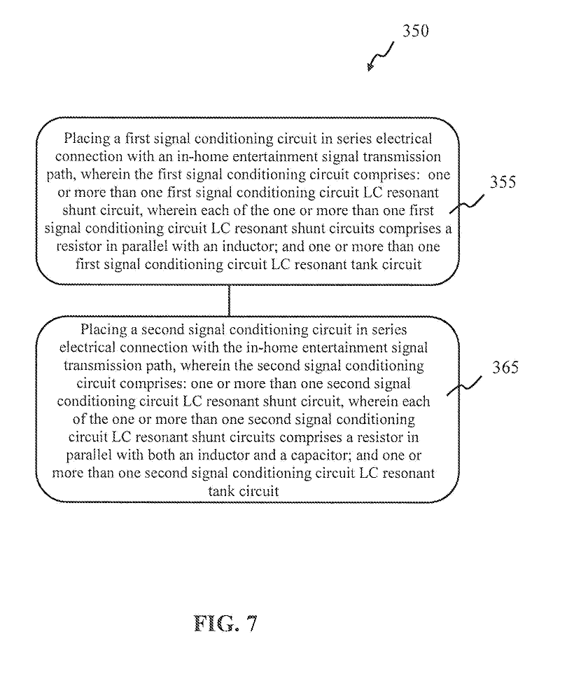

FIG. 7 shows method 350 of conditioning in-home entertainment signals in a CATV system according to the invention. Method 350 includes step 355 placing a first signal conditioning circuit in series electrical connection with an in-home entertainment signal transmission path. The first signal conditioning circuit includes one or more than one first signal conditioning circuit LC resonant shunt circuit, with each of the one or more than one first signal conditioning circuit LC resonant shunt circuits including a resistor in parallel with an inductor. The first signal conditioning circuit also includes one or more than one first signal conditioning circuit LC resonant tank circuit. Method 350 of conditioning IHE signals in a CATV system also includes step 365 placing a second signal conditioning circuit in series electrical connection with the in-home entertainment signal transmission path. The second signal conditioning circuit includes one or more than one second signal conditioning circuit LC resonant shunt circuit, with each of the one or more than one second signal conditioning circuit LC resonant shunt circuits including a resistor in parallel with both an inductor and a capacitor. The second signal conditioning circuit also includes one or more than one second signal conditioning circuit LC resonant tank circuit.

In some embodiments method 350 of conditioning IHE signals in a CATV system includes the step of placing a resistor in series with a capacitor in each of the one or more than one first signal conditioning circuit LC resonant tank circuits. In some embodiments method 350 of conditioning IHE signals in a CATV system includes the step of placing a resistor in parallel with a capacitor in each of the one or more than one second signal conditioning circuit LC resonant tank circuits. In some embodiments the first signal conditioning circuit includes three first signal conditioning circuit LC resonant shunt circuits and two first signal conditioning circuit LC resonant tank circuits. In some embodiments the second signal conditioning circuit includes three second signal conditioning circuit LC resonant shunt circuits and two second signal conditioning circuit LC resonant tank circuits.

While the present invention has been described with reference to a number of specific embodiments, it will be understood that the true spirit and scope of the invention should be determined only with respect to claims that can be supported by the present specification. Further, while in numerous cases herein wherein systems and apparatuses and methods are described as having a certain number of elements it will be understood that such systems, apparatuses and methods can be practiced with fewer than the mentioned certain number of elements. Also, while a number of particular embodiments have been described, it will be understood that features and aspects that have been described with reference to each particular embodiment can be used with each remaining particularly described embodiment. For example, the disclosed signal conditioning circuits 72 and 172 may be realized as stand-along devices, adapted to be coupled to the outlet ports of a conventional splitter or adapter. Or, the disclosed CATV network device 176 may be realized for use in multimedia-over-coax bands with Fiber to the Home networks, or Home Satellite networks. Further embodiments of the disclosed CATV network device 176 may not comprise individual resistors per se, but may include a circuit design with equivalent resistances, thereby reducing the loaded Q factor of the circuit.

1. A signal conditioning circuit for community access television equipment comprising:
an in-home entertainment signal transmission path, wherein the in-home entertainment signal transmission path conducts in-home entertainment signals between a first node and a second node;
a first LC resonant shunt circuit comprising:
a first LC resonant shunt circuit first end electrically coupled to the in-home entertainment signal transmission path;
a first LC resonant shunt circuit second end electrically coupled to a current return path;
a first inductor;
a first capacitor in series with the first inductor; and
a first resistor in parallel with the first inductor; and
a first LC resonant tank circuit coupled in series along the in-home entertainment signal transmission path, wherein the first LC resonant tank circuit comprises a second inductor in parallel with a second capacitor.

2. The circuit of claim 1, wherein the first resistor is in parallel with both the first inductor and the first capacitor.

3. The circuit of claim 1, wherein the first LC resonant tank circuit further comprises a second resistor in series with the second capacitor.

4. The circuit of claim 1, wherein the first LC resonant tank circuit further comprises a second resistor in parallel with the second capacitor.

5. The circuit of claim 3, further comprising:
a second LC resonant shunt circuit comprising:
a second LC resonant shunt circuit first end electrically coupled to the in-home entertainment signal transmission path;
a second LC resonant shunt circuit second end electrically coupled to a current return path;
a third capacitor;
a third inductor in series with the third capacitor; and
a third resistor in parallel with the third inductor; and
a second LC resonant tank circuit coupled in series along the in-home entertainment signal transmission path, wherein the second LC resonant tank circuit comprises a fourth inductor in parallel with a fourth capacitor.

6. The circuit of claim 5, wherein the third resistor is in parallel with both the third inductor and the third capacitor.

7. The circuit of claim 6, wherein the second LC resonant tank circuit further comprises a fourth resistor in parallel with both the fourth inductor and the fourth capacitor.

8. The circuit of claim 5, wherein the second LC resonant tank circuit further comprises a fourth resistor in series with the fourth capacitor.

9. The circuit of claim 8, further comprising:
a third LC resonant shunt circuit comprising:
a third LC resonant shunt circuit first end electrically coupled to the in-home entertainment signal transmission path;
a third LC resonant shunt circuit second end electrically coupled to a current return path;
a fifth capacitor;
a fifth inductor in series with the fifth capacitor; and
a fifth resistor in parallel with the fifth inductor.

10. The circuit of claim 9, wherein the fifth resistor is in parallel with both the fifth inductor and the fifth capacitor.

11. A community access television network device comprising:
a community access television signal transmission path, wherein the community access television signal transmission path conducts community access television downstream signals in a first frequency range and community access television upstream signals in a second frequency range that is different from the first frequency range, and wherein the community access television signal transmission path rejects in-home entertainment signals in a third frequency range that is different from the first frequency range and the second frequency range; and
an in-home entertainment signal transmission path, wherein the in-home entertainment signal transmission path conducts community access television downstream signals in the first frequency range, community access television upstream signals in the second frequency range, and in-home entertainment signals in the third frequency range.

12. The device of claim 11, wherein the in-home entertainment signal transmission path comprises a signal conditioning circuit, the signal conditioning circuit comprising:
at least one LC resonant shunt circuit; and
at least one LC resonant tank circuit.

13. The device of claim 11, wherein the in-home entertainment signal transmission path comprises two signal conditioning circuits, wherein each of the two signal conditioning circuits comprise:
at least one LC resonant shunt circuit; and
at least one LC resonant tank circuit.

14. The device of claim 13, wherein in-home entertainment signals in the third frequency range are attenuated an amount in the range of −1 dB to −30 dB in response to passing through the two signal conditioning circuits.

15. The device of claim 13, wherein in-home entertainment signals in the third frequency range are attenuated an amount in the range of −15 dB to −20 dB in response to passing through the two signal conditioning circuits.

16. A method of conditioning in-home entertainment signals in a community access television system comprising the steps of:
placing a first signal conditioning circuit in series electrical connection with an in-home entertainment signal transmission path, wherein the first signal conditioning circuit comprises:
one or more than one first signal conditioning circuit LC resonant shunt circuit, wherein each of the one or more than one first signal conditioning circuit LC resonant shunt circuits comprise a resistor in parallel with an inductor; and
one or more than one first signal conditioning circuit LC resonant tank circuit; and
placing a second signal conditioning circuit in series electrical connection with the in-home entertainment signal transmission path, wherein the second signal conditioning circuit comprises:
one or more than one second signal conditioning circuit LC resonant shunt circuit, wherein each of the one or more than one second signal conditioning circuit LC resonant shunt circuits comprises a resistor in parallel with both an inductor and a capacitor; and
one or more than one second signal conditioning circuit LC resonant tank circuit.

17. The method of claim 16, further comprising the step of:
placing a resistor in series with a capacitor in each of the one or more than one first signal conditioning circuit LC resonant tank circuits.

18. The method of claim 17, further comprising the step of:
placing a resistor in parallel with a capacitor in each of the one or more than one second signal conditioning circuit LC resonant tank circuits.

19. The method of claim 18, wherein the first signal conditioning circuit comprises:
three first signal conditioning circuit LC resonant shunt circuits; and
two first signal conditioning circuit LC resonant tank circuits.

20. The method of claim 19, wherein the second signal conditioning circuit comprises:
three second signal conditioning circuit LC resonant shunt circuits; and
two second signal conditioning circuit LC resonant tank circuits.
